(19) United States
(12) Patent Application Publication
(10) Pub. No.: US 2007/0252905 A1
(43) Pub. Date: Nov. 1, 2007

(54) IMAGE PROCESSING APPARATUS

(75) Inventors: Yasuaki Kamiya, Iwata-shi (JP); Mitsuhiro Honme, Hamamatsu-shi (JP)

Correspondence Address: ROSSI, KIMMS & McDOWELL LLP., P.O. BOX 826, ASHBURN, VA, 20146-0826, US

(73) Assignee: YAMAHA CORPORATION, Hamamatsu-shi (JP)

(21) Appl. No.: 11/738,090

(22) Filed: Apr. 20, 2007

(30) Foreign Application Priority Data
Apr. 21, 2006 (JP) 2006-118515

(51) Int. Cl. H04N 5/217; G02B 13/16

(52) U.S. Cl. 348/241; 348/335

(57) ABSTRACT

An image processing apparatus is designed for displaying an image written in a video memory, on a display device in the form of an array of dots, by performing distortion correction of the image based on a distortion rate, and by performing tilt correction of the image based on a tilt angle. In the image processing apparatus, a first computing part computes a position before the tilt correction based on the tilt angle, for each dot of the image displayed in the display device. A second computing part computes a position before the distortion correction based on the distortion rate, for each position computed by the first computing part. A color data computing part computes color data of the position computed by the second computing part, based on color data of dots around the position in the video memory.

### BACKGROUND OF THE INVENTION

1. Technical Field

The present invention relates to an image processing apparatus used in display devices or the like which display, in real time, image data in NTSC format, PAL format or the like, taken by a video camera.

2. Related Art

An apparatus to display an image taken by a video camera (image data by means of video capture) in a display device by expanding or reducing in real time has been developed in the recent years. This apparatus is used, for example, for monitoring a rear side of a vehicle invisible from a driver, with a video camera fixed to the rear of the vehicle, in combination with an image processing device and a display device mounted in the interior of the vehicle. For example, Japanese Unexamined Patent Publication No. 2004-147285 discloses such an apparatus.

### SUMMARY OF THE INVENTION

Meanwhile, the image taken by the video camera has distortion due to a lens, as is well known. Further, when mounting the camera to the vehicle or the like, it is difficult to fix it completely horizontally, and the occurrence of a tilt is unavoidable.

The present invention has been achieved in consideration of the forgoing circumstances, and has for its object to provide an image processing apparatus capable of performing distortion correction and tilt correction, thereby being capable of displaying an image having neither distortion nor tilt.

This invention has been made to achieve the above noted object, and in one aspect of the invention, there is provided an image processing apparatus for displaying an image written in a video memory, on a display device in the form of an array of dots, by performing distortion correction of the image based on a distortion rate, and by performing tilt correction of the image based on a tilt angle. The inventive the image processing apparatus comprises: a first computing part that computes a position before the tilt correction based on the tilt angle, for each dot of the image displayed in the display device; a second computing part that computes a position before the distortion correction based on the distortion rate, for each position computed by the first computing part; and a color data computing part that computes color data of the position computed by the second computing part, based on color data of dots around the position in the video memory.

In another aspect of the invention, there is provided an image processing apparatus for displaying an image written in a video memory, on a display device in the form of an array of dots, by performing distortion correction of the image based on a distortion rate, performing tilt correction of the image based on a tilt angle, and performing expansion/reduction of the image based on an expansion/reduction ratio. The inventive image processing apparatus comprises: a first computing part that computes a position of each dot before the expansion/reduction based on an inverse number of the expansion/reduction ratio and position data indicating a display position of each dot displayed in the display device; a second computing part that computes a position before the tilt correction based on the tilt angle, for each position computed by the first computing part; a third computing part that computes a position before the distortion correction based on the distortion rate, for each position computed by the second computing part; and a color data computing part that computes color data of the position computed by the third computing part, based on color data of dots around the position in the video memory.

In one form of the inventive image processing apparatus, the color data computing part computes the color data according to a bilinear method.

In another form of the inventive image processing apparatus, the color data computing part computes the color data according to a nearest neighbor method.

In accordance with this invention, the distortion correction and the tilt correction can be carried out to perform image display, thereby enabling an image free from distortion or tilt to be displayed.

### BRIEF DESCRIPTION OF THE DRAWINGS

FIG. 1 is a block diagram showing the configuration of an image processing apparatus according to an embodiment of the present invention.

FIG. 2 is a block diagram showing the configuration of a CPC in the image processing apparatus.

FIG. 3 is an explanatory diagram for explaining the operation of an image correction circuit implemented in the CPC.

FIG. 4 is a flow chart for explaining the operation of the image correction circuit.

FIG. 5 is an explanatory diagram for explaining expansion/reduction process performed in the image correction circuit.

FIG. 6 is an explanatory diagram for explaining tilt correction process performed in the image correction circuit.

FIG. 7 is an explanatory diagram for explaining distortion correction process performed in the image correction circuit.

FIG. 8 is an explanatory diagram for explaining distortion correction process performed in the image correction circuit.

FIG. 9 is an explanatory diagram for explaining image data computing process performed in the image correction circuit.

### DETAILED DESCRIPTION OF THE INVENTION

An embodiment of an image processing apparatus according to the present invention will be described below with reference to the drawings. This image processing apparatus is used, for example, for monitoring a rear side of a vehicle invisible from a driver, with a video camera fixed to the rear of the vehicle, in combination with a display device mounted in the interior of the vehicle.

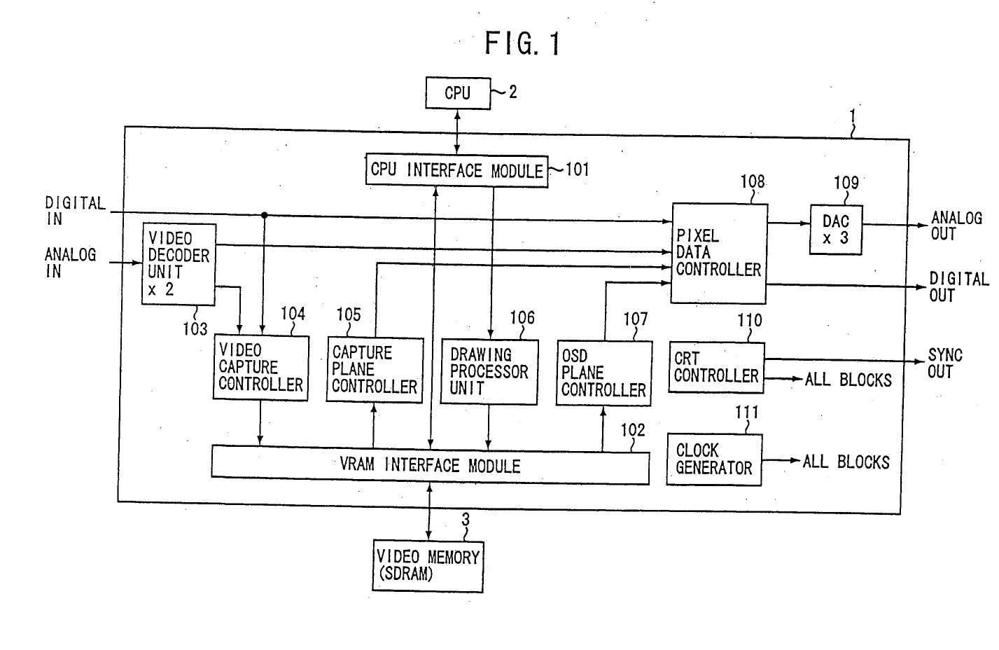

FIG. 1 is a block diagram showing the configuration of a VDP (Video Display Processor; an image processing apparatus) according to an embodiment of the present invention. In FIG. 1, the VDP 1 captures a video input and writes it in a video memory 3, and thereafter directs a CRT display device (not shown) to display it in accordance with a display resolution. The VDP 1 also has a function of inputting a drawing command from a CPU (Central Processing Unit) 2, and performing an OSD (On Screen Display) display to the video input. In another form, an LCD (liquid Crystal Display) or other display device may be used as a monitor instead of the CRT display device.

In the present embodiment, three kinds of commands consisting of LINE command, FILL command, and COPY command are used as the drawing command. The LINE command is a command to perform a linear drawing by designating an initial node and a terminal node, and the FILL command is a command to perform filling by designating a rectangular region. The COPY command is a command to perform copying of data in a video memory space by designating a source address and a destination address. The COPY command further includes information of designating a format conversion, and information of transparent color control and of setting a blending.

A CPU interface module 101 in the VDP 1 governs communications with the CPU 2, and has a function of outputting a drawing command inputted from the CPU 2 to a DPU 106, and a function of controlling access from the CPU 2 to the video memory 3. A VRAM interface module 102 controls access from each part within the VDP 1 to the video memory 3.

A VDU (Video Decoder Unit) 103 inputs an analog image signal and converts it to a digital image signal. A VCC (Video Capture Controller) 104 captures a digital image signal outputted from the VDU 103, or a digital image signal directly inputted from the exterior, and writes it as image data in the video memory 3. There are provided two decoder circuits of the VDU 103 and two capture circuits of the VCC 104, so that two channels of analog image signal inputs can be captured at the same time.

A CPC (Capture Plane Controller) 105 reads image data from the video memory 3, and outputs the data to a PDC 108. A DPU (Drawing Processor Unit) 106 interprets a drawing command inputted from the CPU interface module 101, and draws a line or a rectangle in the video memory 3, and performs a predetermined process to the drawn data. The CPU 2 can also directly draw in the video memory 3 without using the drawing command.

An OSD plane controller 107 reads data to be displayed as an OSD image, from a video memory 8, and outputs the data to the PDC 108. The PDC (Pixel Data Controller) 108 directs a back drop plane to directly display image inputs, namely, an image based on the digital image signal inputted from the exterior, and an image based on the digital image signal after being decoded by the VDU 103. It also inputs capture image data outputted from the CPC 105, and data for displaying as an OSD image outputted from the OSD plane controller 107, and unifies the formats of the respective planes, and performs synthesis process based on the priority of display and the setting of α blending, or the like.

The VDP 1 enables hierarchy display by means of a back drop plane and four display planes consisting of the back drop plane for displaying an image inputted from the exterior, two display planes for displaying capture image data and two display planes for displaying an OSD image. The PDC 108 performs synthesis process of the four display planes and the back drop plane.

The term “display plane” indicates one containing all the necessary configurations for displaying a single rectangular image data at a predetermined location of an external display device and at a predetermined size, or indicates display data themselves to be supplied to the external display device.

The PDC 108 directly outputs display data after synthesis to the outside as a digital image signal and outputs as is to the exterior, and also outputs it as an analog image signal via a DAC (Digital Analog Converter) 109. The CRT controller 110 outputs a timing signal used when displaying images on a CRT display device, and also outputs information related to monitor display to each part in the VDP 1. A clock generator 111 generates clocks used at individual parts in the VDP 1.

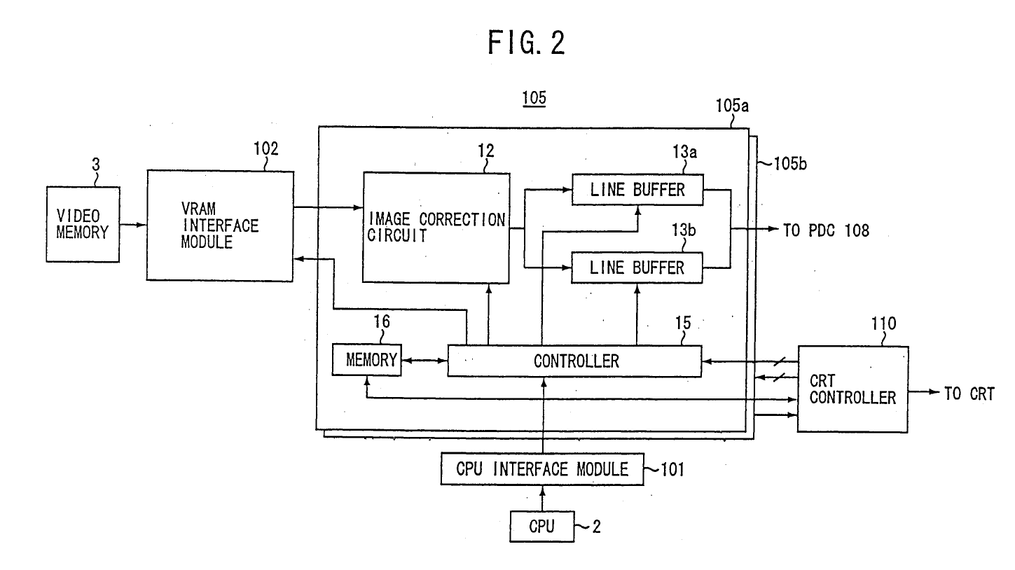

FIG. 2 is a block diagram showing the details of the CPC 105 in FIG. 1, which is formed from two display planes 105a and 105b having the same configuration. In the display plane 105a, reference number 12 is an image correction circuit, which reads image data of a video camera from the video memory 3 via the interface module 102, and writes image data in line buffer 13a or 13b, after correcting the distortion due to a lens, correcting the tilt of the image due to the tilt of the camera, and further expanding or reducing the image data. The image correction circuit 12 performs the correcting of the distortion of the image, the correcting of the tilt of the image and the expanding or reducing of the image data by computing the image data using various parameters (such as Scalx, Scaly, θ and k1, described later in detail) which are provided from CPU 2 to the image correction circuit 12 through the CPU interface module 101 and controller 15. In case of using the image processing apparatus with mounting a video camera in a rear side of a vehicle, these parameters may be properly set manually by a driver of the vehicle while the driver checks the image captured by the video camera on a monitor display. Alternatively, these parameters may be preset by a vehicle maker according to a mounting position of a video camera and a type of the video camera. Otherwise, these parameters may be automatically set according to an automatic correction algorism executed by the CPU.

The line buffers 13a and 13b are first-in, first-out buffer memories where writing and reading are performed alternately. When the output of the image correction circuit 12 is being written in the line buffer 13a, the data within the line buffer 13b are read. When the output of the image correction circuit 12 is being written in the line buffer 13b, the data within the line buffer 13a are read. These operations are performed alternately. Reference number 15 is a controller, which controls each part of the circuit based on the data within the memory 16.

The image correction circuit 12 will next be described in detail.

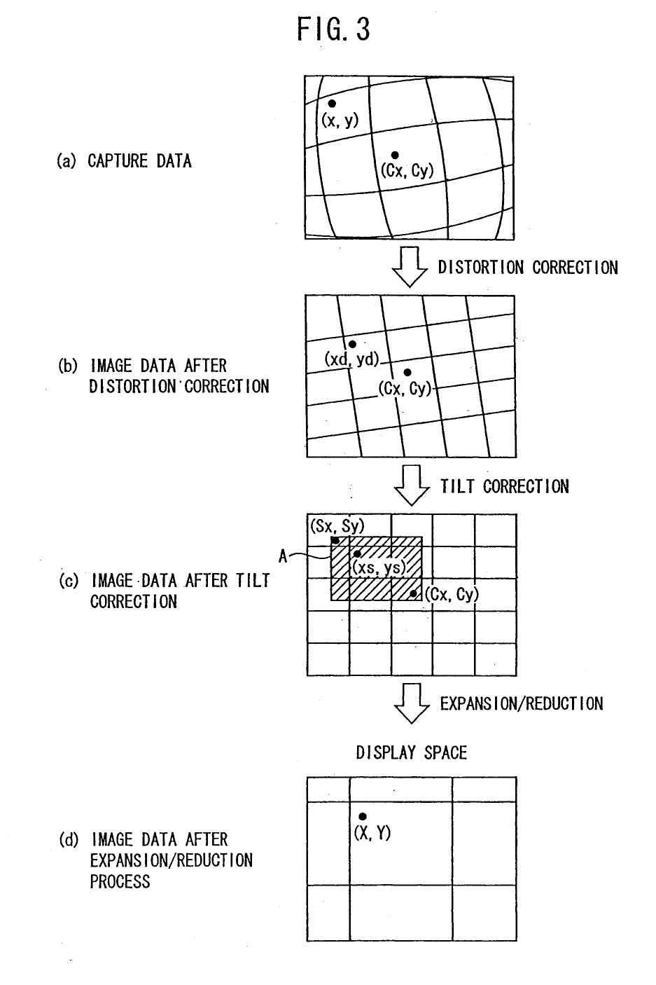

FIG. 3 is a diagram showing the contents of a process performed in the image correction circuit 12. In this figure, FIG. 3(a) shows capture data obtained by the video camera, and FIG. 3(b) shows image data after distortion correction. The dot of a point (x, y) in the capture data is shifted to a point (xd, yd) by the distortion correction. A point (Cx, Cy) is the center of image data serving as a reference of distortion correction or tilt correction. FIG. 3(c) shows image data after tilt correction. A point (xd, yd) after distortion correction is shifted to a point (xs, ys) by the tilt correction. FIG. 3(d) shows image data after expansion/reduction process. This figure shows the case of expanding a display region A in FIG. 3(c), and a point (xs, ys) after tilt correction is displayed at a point (X, Y).

The foregoing is the contents of the process in the image correction circuit 12, and the actual process is performed in the reverse order of the above. The reason for this is that, though the capture data are dot data, the position of each dot to be color-displayed by the capture data does not always match with a dot position of a display image when performed correction process and expansion/reduction process; rather, it often mismatches. Conversely, by finding the dot position of the capture data from the dot position of a display image, the color data of the dots of the display image can be found from the color data of dots around the found position.

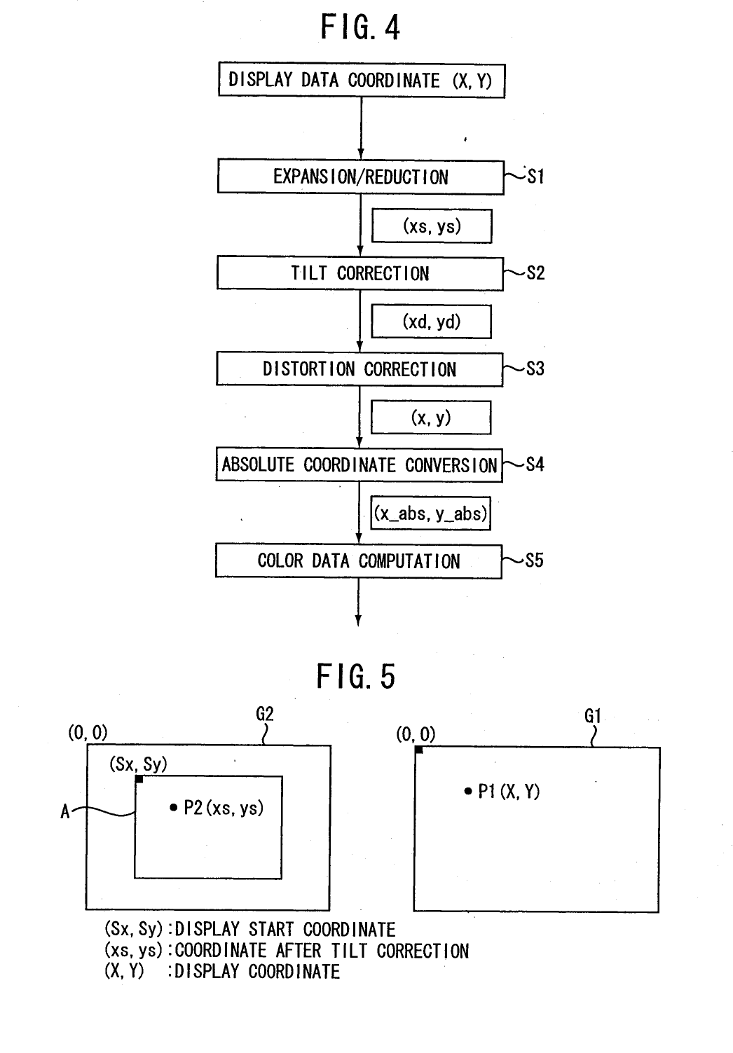

FIG. 4 is a flow chart showing the procedure of the process in the image correction circuit 12. Now, suppose that a coordinate (X, Y) in FIG. 3 is the coordinate of a certain dot after expansion process, the image correction circuit 12 firstly obtains the coordinate (xs, ys) of a point in the image data after tilt correction (FIG. 3(c)) of the point (X, Y) (step S1). In this case, computation is made by a relative coordinate using, as a reference, the coordinate of a point at which display is started on the display device 4. Next, it obtains the coordinate (xd, yd) of the point in the image data after distortion (FIG. 3(b)) of the point (xs, ys) (step S2). In this case, computation is made by a relative coordinate using, as a reference point, the central coordinate (Cx, Cy) of the image data. Next, it obtains the coordinate (x, y) of the point in the capture data (FIG. 3(a)) of the point (xd, yd) (step S3). In this case, computation is made by a relative coordinate using, as a reference point, the central coordinate (Cx, Cy) of the image data. Next, the relative coordinate is converted to an absolute coordinate (step S4), and then the color data of dots of the point (X, Y) is computed (step S5).

The above process will be described below specifically.

(1) Expansion/Reduction

In FIG. 5, suppose that G2 is virtual image data after tilt correction, and G1 is image data after expanding a display region A of the virtual image data G2. Here, “virtual image data” are not image data to be displayed actually, and image data virtually considered for the convenience in description. On the other hand, the image data G1 are image data to be displayed actually on a display device.

Now, suppose that the coordinate of a point at the left and upper corner in the display region A is (Sx, Sy). Here, the origin of coordinates is the point at the left and upper corner of the image data G2. Also suppose that a point in the display region A, which corresponds to a dot P1 (X, Y) in the image data G1, is P2. At this time, the coordinate (xs, ys) of the point P2 with the left and upper corner of the image data G2 as the origin can be found from the following equations:
Xs=Scalx·X+Sx (1)
Ys=Scaly*Y+Sy (2)
where Scalx and Scaly are the inverse number of expansion/reduction ratio.
(2) Tilt Correction

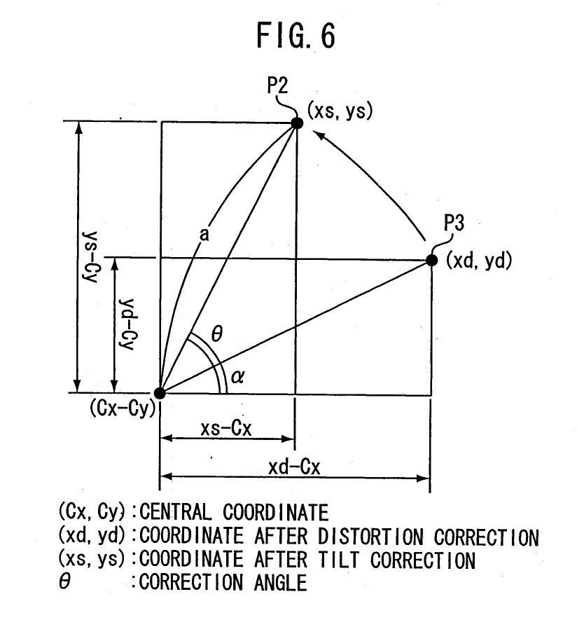

FIG. 6 is a diagram for explaining tilt correction, wherein a point P2 is the position of the point after tilt correction, a point P3 is the position of the point before tilt correction, and an angle θ is a correction angle. In this case, a distance (xd-Cx) in the x-axis direction and a distance (yd-Cy) in the y-axis direction from the central coordinate (Cx, Cy) of the image data G2 to the point P3, and a distance (xs-Cx) in the x-axis direction and a distance (ys-Cy) in the y-axis direction from the central coordinate (Cx, Cy) to the point P2 can be found from the following equations:
(xd−Cx)=a·cos α (3)
(yd−Cy)=a·sin α (4)
(xs−Cx)=a·cos(θ+α) (5)
(ys−Cy)=a·sin(θ+α) (6)
where a is a distance from the central point to the point P2 or P3.

From the above equations (5) and (6), the following equations are obtained:
(xs−Cx)=a·cos α·cos θ−a·sin α·sin θ (7)
(ys−Cy)=a·sin α·cos θ+a·cos α·sin θ (8)
Substitution of the equations (3) and (4) into the equations (7) and (8), respectively, yields the following equations:
(xs−Cx)=(xd−Cx)·cos θ−(yd−Cy)·sin θ (9)
(ys−Cy)=(yd−Cy)·cos θ+(xd−Cx)·sin θ (10)
From these equations (9) and (10), the coordinate (xd, yd) of the point P3 before tilt correction can be found as follows:
xd=Cx+(xs−Cy)·cos θ+(yz−Cy)·sin θ (11)
yd=Cy+(ys+Cy)·cos θ−(xs−Cx)·sin θ (12)
(3) Distortion Correction

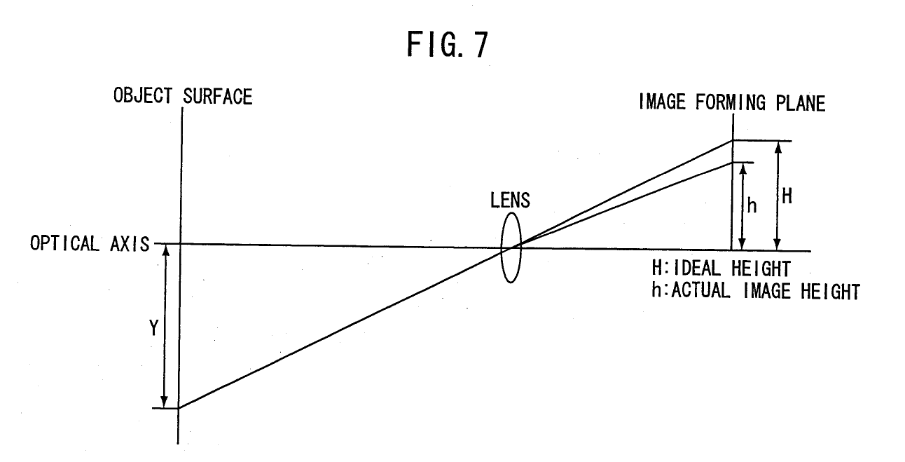

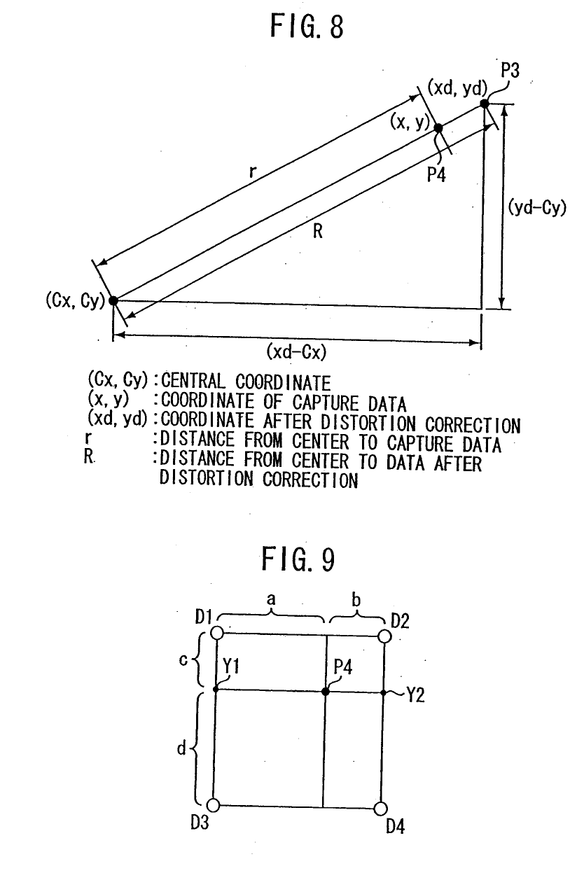

FIG. 7 and FIG. 8 are diagrams for explaining distortion correction. In FIG. 7, an object from an optical axis a distance Y can be ideally formed at a position H, however, it is actually formed at a position h due to the influence of a lens. At this time, h/H becomes magnification. If this magnification is constant irrespective of the value of H, no distortion will occur. However, barrel distortion will occur when the magnification decreases with increasing H, and pincushion distortion will occur when it increases. The magnification h/H can be approximated by the following polynomial.
h/H=1+k1·H²+k2·H²+k3·H²+ . . . (13)
From this equation, h is found as follows:
h=H·(1+k1·H²+k2H²+k3·H²+ . . . ) (14)

Next, in FIG. 8, P3 is the position of the point after distortion correction, and P4 is the position of the point before distortion correction. Now, if the distance from the central point (Cx, Cy) to the point P4 is r, and the distance to the point P3 is R, then the following relationships hold.
r=R·(1+k1*R²+k2·R²+k3·R²+ . . . ) (15)
r/R=(x−Cx)/(xd−Cd)=(y−Cy)/(yd−Cy) (16)
From these equations (15) and (16), the following relationships are obtained.
(x−Cx)=(xd−Cx)·(1+k1·R²+k2·R²·+k3·R²+ . . . ) (17)
(y−Cy)=(yd−Cy)·(1+k1·R²+k2·R²·+k3·R²+ . . . ) (18)
If distortion correction is secondarily approximated in these equations (17) and (18), then the following equations are obtained.
(x−Cx)=(xd−Cx)·(1+k1·R²) (19)
(y−Cy)=(yd−Cy)·(1+k1·R²) (20)
From these equations, the following equations are obtained, and the coordinate (x, y) of the point P4 can be found.
x=Cx+(xd−Cy)·(1+k1·R²) (21)
y=Cy+(yd−Cy)·(1+k1·R²) (22)
where R²=(xd−Cx)²+(yd−Cy)²
(4) Color Data Computation

Through the foregoing computation, it is possible to find a correspondence between a positional point of the capture data (FIG. 3(a)) and the dot P1 on the display image data G1 shown in FIG. 5. The point thus found is the point P4 (x, y). Although the point P4 might just match with the dot position of the capture data, it may often mismatch. Consequently, the image correction circuit 12 computes the color data of the point P4, namely, the color data of the point P1, from the capture data (color data) of four points around the point P4 by bilinear method.

In FIG. 9, suppose that four dots around the point P4 are D1 to D4, the lateral distance between the point P4 and the point D1 is “a”, the lateral distance between the point P4 and the point D2 is “b”, the longitudinal distance between the point P4 and the point D1 is “c”, and the longitudinal distance between the point P4 and the point D3 is “d”. Then, the color data of the point P4 can be found from the following equations, and the actual computation is performed by an FIR filter.
Color data of point Y1: (dD1/(c+d))+(cD3/(c+d))
Color data of point Y2: (dD2/(c+d))+(cD4/(c+d))
Color data of point P4: (bY1/(a+b))+(aY2/(a+b))

Instead of the above-mentioned bilinear method, nearest neighbor method may be used to find the color data of the point P4. In the case of the nearest neighbor method, the color data of the nearest dot in the four points D1 to D4 are employed as the color data of the point P4.

Although the above embodiment has the functions of distortion correction, tilt correction, and expansion/reduction, it may be configured as a circuit having only any one or two functions.

This invention is applicable to display devices or the like which display, in real time, image data in NTSC format, PAL format or the like, taken by a video camera.

What is claimed is:

1. An image processing apparatus for displaying an image written in a video memory, on a display device in the form of an array of dots, by performing distortion correction of the image based on a distortion rate, and by performing tilt correction of the image based on a tilt angle, wherein the image processing apparatus comprises:
a first computing part that computes a position before the tilt correction based on the tilt angle, for each dot of the image displayed in the display device;
a second computing part that computes a position before the distortion correction based on the distortion rate, for each position computed by the first computing part; and
a color data computing part that computes color data of the position computed by the second computing part, based on color data of dots around the position in the video memory.

2. The image processing apparatus as set forth in claim 1, wherein the color data computing part computes the color data according to a bilinear method.

3. The image processing apparatus as set forth in claim 1, wherein the color data computing part computes the color data by a nearest neighbor method.

4. An image processing apparatus for displaying an image written in a video memory, on a display device in the form of an array of dots, by performing distortion correction of the image based on a distortion rate, performing tilt correction of the image based on a tilt angle, and performing expansion/reduction of the image based on an expansion/reduction ratio, wherein the image processing apparatus comprises:
a first computing part that computes a position of each dot before the expansion/reduction based on an inverse number of the expansion/reduction ratio and position data indicating a display position of each dot displayed in the display device;
a second computing part that computes a position before the tilt correction based on the tilt angle, for each position computed by the first computing part;
a third computing part that computes a position before the distortion correction based on the distortion rate, for each position computed by the second computing part; and
a color data computing part that computes color data of the position computed by the third computing part, based on color data of dots around the position in the video memory.

5. The image processing apparatus as set forth in claim 4, wherein the color data computing part computes the color data according to a bilinear method.

6. The image processing apparatus as set forth in claim 4, wherein the color data computing part computes the color data by a nearest neighbor method.

7. An image processing method for displaying an image written in a video memory, on a display device in the form of an array of dots, by performing distortion correction of the image based on a distortion rate, and by performing tilt correction of the image based on a tilt angle, wherein the image processing method comprises:
a first computing step of computing a position before the tilt correction based on the tilt angle, for each dot of the image displayed in the display device;
a second computing step of computing a position before the distortion correction based on the distortion rate, for each position computed by the first computing step; and
a color data computing step of computing color data of the position computed by the second computing step, based on color data of dots around the position in the video memory.

8. An image processing method for displaying an image written in a video memory, on a display device in the form of an array of dots, by performing distortion correction of the image based on a distortion rate, performing tilt correction of the image based on a tilt angle, and performing expansion/reduction of the image based on an expansion/reduction ratio, wherein the image processing method comprises:
a first computing step of computing a position of each dot before the expansion/reduction based on an inverse number of the expansion/reduction ratio and position data indicating a display position of each dot displayed in the display device;
a second computing step of computing a position before the tilt correction based on the tilt angle, for each position computed by the first computing step;
a third computing step of computing a position before the distortion correction based on the distortion rate, for each position computed by the second computing step; and
a color data computing step of computing color data of the position computed by the third computing step, based on color data of dots around the position in the video memory.
